(19) United States
(12) Patent Application Publication
(10) Pub. No.: US 2005/0269805 A1
(43) Pub. Date: Dec. 8, 2005

(54) Device for protecting a person outside a motor vehicle

(75) Inventors: Ingo Kalliske, Potsdam (DE); Sami Al-Samarae, Berlin (DE); Henning Wigger, Berlin (DE)

Correspondence Address: FOLEY AND LARDNER;SUITE 500, 3000 K STREET NW, WASHINGTON, DC, 20007, US

(73) Assignee: TAKATA-PETRI AG

(21) Appl. No.: 10/521,735

(22) PCT Filed: Jul. 11, 2003
(86) PCT No.: PCT/DE03/02397

§ 371 Date: Jul. 21, 2005

(30) Foreign Application Priority Data
Jul. 19, 2002 (DE) 102 33 593.1

(51) Int. Cl. B60R 21/34

(52) U.S. Cl. 280/730.1; 180/274

(57) ABSTRACT

The invention relates to a device for protecting a person outside a motor vehicle, especially pedestrians or cyclists, said device comprising at least one inflatable gas bag which acts outside the motor vehicle. When inflated, said gas bag (2) comprises a contact region (21) in the lower region thereof in relation to the motor vehicle (1), for the first contact with a person in the event of a collision, said contact region being located further away from the body (1) of the motor vehicle than other regions of the gas bag (2), perpendicularly in relation to the vertical axis of the motor vehicle. The gas bag (2) also comprises an impact surface (20) which is adjacent to the contact region (21) and absorbs the impact of the person (3) after the first contact. The invention thus provides an improved device for protecting people outside motor vehicles, which reduces the known disadvantages of prior art.

### DESCRIPTION

The invention relates to a device for protecting a person outside a motor vehicle in accordance with the precharacterizing clause of claims 1, 14, 20, 30 and 32.

Accidents with pedestrians or other people outside a motor vehicle frequently have serious consequences, since there is a very high risk of injury against the rigid bodywork of the motor vehicle. In particular, in the event of a collision, the people may also become injured against protruding parts, such as, for example, windshield wipers and in the region of the window frame. The lack of an energy-absorbing “crumple zone”, which is tailored with regard to people who are substantially lighter than the vehicle weight, causes virtually the entire kinetic energy of the motor vehicle in an accident to act immediately and without damping on the people who are involved outside the motor vehicle.

It is therefore known to provide airbags outside motor vehicles, in particular in the front region of motor vehicles, in order to reduce the consequences of a collision with people outside the motor vehicle. The effect ideally to be achieved by the airbags is that, for example, pedestrians do not incur any injuries at all from a collision with a motor vehicle.

JP 2 001 315 599 A discloses an airbag which can be deployed in the front region of a motor vehicle. The airbag is directed upward from the bumper and forms a club-like shape.

JP 06 239 198 A discloses an airbag which is provided in the front region of a motor vehicle and covers the front region together with the bumper.

The problem with the known shapes of airbags for outside a motor vehicle is that, when they first make contact with a person during a collision, they provide only an insufficient deceleration distance for the dissipation of energy or only cover the front region of the vehicle. If there is a collision of people with a vehicle equipped in such a manner, there therefore continues to be a considerable risk of injuries.

It is therefore the object of the present invention to specify an improved device for protecting, in the event of collisions, people outside motor vehicles, said device reducing the known disadvantages of the prior art.

The object is achieved by a device for protecting people outside a vehicle, having the features of claim 1. Advantageous refinements of the invention are specified in the dependent subclaims.

Accordingly, the device for protecting a person outside a motor vehicle, in particular pedestrians or cyclists, has at least one inflatable airbag acting outside the motor vehicle. According to the invention, when inflated, the airbag comprises, in its lower region in relation to the motor vehicle, a contact region for the first contact with a person in the event of a collision. This contact region is at a greater distance from the motor vehicle body perpendicularly to the vertical axis of the motor vehicle than other regions of the airbag. Furthermore, the airbag comprises an impact surface adjoining the contact region for receiving a person after the first contact.

In one advantageous development of the invention, the impact surface is inclined with respect to the plane running perpendicularly to the vertical axis of the vehicle. It is advantageous in this case if the impact surface rises counter to the direction of travel. In a further advantageous development of the invention, the impact surface extends essentially obliquely with respect to the longitudinal direction of the vehicle above the contact region. The resultant advantageous shape of the inflated airbag is essentially in the form of a wedge. In a further advantageous refinement of the invention, the contact region is arranged essentially on a plane below the center of gravity of the body, in particular level with the lower legs, of a person located outside the motor vehicle. The low-lying contact region means that, in the event of a collision, these airbag formations cause the person to first of all move in a slight rotational movement, in which the upper body of the person moves towards the vehicle. As a result, the person gradually comes into contact with the impact surface and is virtually rolled onto the latter.

It is advantageous to adapt the inclination and/or the stiffness of the impact surface to factors influencing the impact kinematics, i.e. in particular, the vehicle speed and the angle of impact. In one preferred variant, the airbag therefore has at least two chambers which can be pressurized to different extents, each of the chambers advantageously being assigned at least one gas generator. In a further variant of the invention, the impact surface is dimensioned in such a manner that the person can be brought fully into contact with it. These different configurations make it possible for the person to be received on the airbag with as little pulse transmission as possible and to come to rest thereon in the manner as in a completely inelastic impact. The risk of injury is thus reduced and the person does not hit the road, or hits it only at a low speed.

In a further embodiment of the invention, the airbag has at least one contact region which, in the event of a collision, can be brought into first contact with the person preferably level with the lower legs of the person. Use can also be made of a contact region which is separate from the rest of the airbag and which causes the slight rotation of the upper body of the person in the direction of the impact surface of the airbag.

It is advantageous for the deployment of the airbag to be triggered via at least one proximity sensor for detecting the people outside the vehicle.

It can thus be ensured that the airbag, for example by early ignition of a gas generator, has already been completely inflated at the instant of the impact and thus has a full safety effect.

It is advantageous to arrange the airbag in the front region of the vehicle, since most accidents with passers-by and cyclists take place in this region. However, the airbags may also be provided at the side and rear of the vehicle in order to achieve optimum protection.

In one advantageous refinement of the invention, the airbag, when not in use, is accommodated in a bumper and/or a protective strip. There is thus no interference with the contours of the vehicle, and so aerodynamics and design are not affected, and at the same time the airbag may be provided directly in the frontmost region of the vehicle.

The object is furthermore achieved by a device for protecting a person outside motor vehicle, having the features of claim 14. Advantageous developments of the invention are specified in the dependent subclaims.

Accordingly, the device for protecting at least one person outside the motor vehicle has at least one inflatable airbag acting outside the motor vehicle. According to the invention, the airbag can at least partially be filled with relative wind.

It is advantageous to make the airbag fillable with relative wind through an air inlet open in the direction of travel, and to close the air inlet in a gastight manner before, during or after ignition of the gas generator. It is furthermore advantageous to arrange the air inlet on a vehicle part, in particular the bumper. In a further variant of the invention, the air inlet is formed as an opening in the airbag. The large volume necessary for an outside airbag can thus partially be filled with relative wind before the airbag is finally filled and deployed by the gas generator. As a result, use can be made of relatively small gas generators, which is expedient for cost reasons and permits a relatively small overall mass with a lower weight.

In one refinement of the invention, the airbag has at least one intercepting cable which acts, on the one hand, on an edge region of the air inlet opening and, on the other hand, on a fixing point on the airbag, which fixing point lies opposite this edge region with respect to the opening, such that, as the pressure in the airbag rises, the opening is closed by the intercepting cable. It is advantageous here if the airbag has at least two chambers, the air inlet opening leading into a first chamber and the gas generator leading into a second chamber and the fixing point of the intercepting cable being arranged on the second chamber. The use of the intercepting cable provides a simple closing mechanism of the air inlet opening provided in the airbag. By means of the connection of the intercepting cable to the second chamber, the air inlet opening is automatically closed, in the event of the gas generator being ignited, by the pressure building up in the second chamber. This takes place independently of the pressure in the first chamber and therefore is also independent of the vehicle speed. The closure of the air inlet opening can thus be brought about in a simple and reliable manner without the use of further means.

The object is furthermore achieved by a device for protecting a person outside a motor vehicle, having the features of patent claim 20. Advantageous refinements of the invention are also specified here in the subclaims.

Accordingly, the device for protecting a person outside a motor vehicle has at least two airbags which are arranged outside the motor vehicle and the impact surfaces of which airbags have essentially the same orientation.

In an advantageous refinement of the invention, the impact surfaces of the airbags are spatially separated from one another and are connected to one another by at least one connecting surface of the same orientation. It is advantageous to form the connecting surface by airbag covering material stretched between the airbags. In one development, the connecting surface is also formed as an airbag, the latter advantageously being formed as a high-pressure airbag. The use of a plurality of spatially separated airbags which are connected to one another by a connecting surface makes it possible to save on airbag volume, as a result of which smaller gas generators can be used and the deployment behavior and the deployment speed of the device are improved.

In a further refinement of the invention, the impact surfaces of the inflated airbags adjoin one another essentially without a gap. It is advantageous if, in the event of triggering, at least one of the airbags is not inflated. In one development, at least one gas generator which can be assigned to just one of at least two airbags is provided for filling the airbags. In a further advantageous refinement, at least one gas generator is provided for the simultaneous filling of at least two airbags. These developments of the invention make it possible to reduce the damage to the vehicle that occurs in the event of the airbags being triggered, since, for example, only a maximum of two airbags and two gas generators or the propellants thereof have to be replaced. In the case of an anticipated impact, which is detected by proximity sensors, for example in the center of one airbag, only this one airbag has to be inflated. In the case of an anticipated impact in the region between two airbags, these two airbags have to be inflated. A deployment and inflation of all of the airbags which are present is therefore not necessary, thus enabling costs to be saved.

The object is furthermore achieved by a device for protecting people outside a motor vehicle, having the features of claim 30, and by a device of this type having the features of claim 32.

Accordingly, the device for protecting a person outside a motor vehicle has at least one inflatable airbag acting outside the motor vehicle and having at least two chambers, at least two of the chambers, when the airbag is inflated, being arranged one above another along the vertical axis of the vehicle, and the chamber arranged in the lower region of the airbag being more highly pressurized than the chamber situated above it. In this case, it is advantageous if the chamber arranged in the lower region is more highly pressurized than each of the chambers situated above it.

To achieve the object, in a further variant, the device comprises at least two inflatable airbags acting outside the motor vehicle, at least two of the airbags, when inflated, being arranged one above another along the vertical axis of the motor vehicle, and the airbag arranged in the lower region being more highly pressurized that the airbag situated above it. It is also advantageous here for the airbag arranged in the lower region to be more highly pressurized than each of the airbags situated above it.

The two abovementioned embodiments of the invention are advantageously developed by the impact surface formed by the inflated airbags and intended for receiving a person extending essentially along the vertical axis of the motor vehicle before the first contact with the person. In this case, the impact surface extends essentially perpendicularly to the longitudinal axis of the motor vehicle preferably before the contact with the person. These developments make it possible, by means of the immediate contact with the entire height of the person involved in the accident, to achieve a controlled impact and movement behavior. In particular, even moments of rotation of the person's body are introduced into the airbag in a controlled manner.

It is advantageous if the gas pressures prevailing in the airbags and/or chambers are adapted to the respectively prevailing kinematic conditions of the expected impact. This ensures optimum utilization of the protective potential of the device.

In addition to reducing the accident consequences of the primary impact, the above-described devices also reduce the consequences of the secondary impact of the person involved in the accident against the carriageway or against other objects in the environment of the carriageway. Because of the extensive reception against the airbags and therefore the vehicle, the person does not impact against the airbag, but rather advantageously only slides down on the latter, thus substantially reducing the consequences of the secondary impact.

The invention is explained below with reference to the exemplary embodiments illustrated in the drawings of the figures, in which:

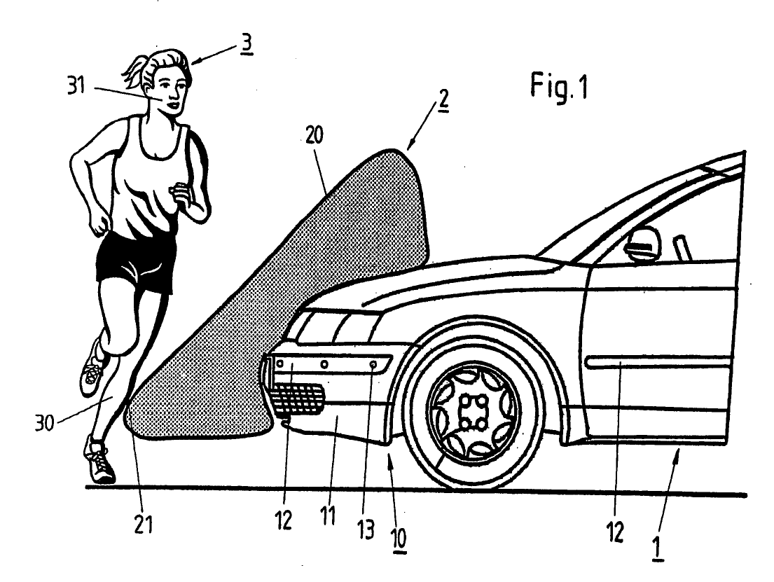

FIG. 1 shows a lateral view of a vehicle with a device according to the invention for protecting a person outside a motor vehicle;

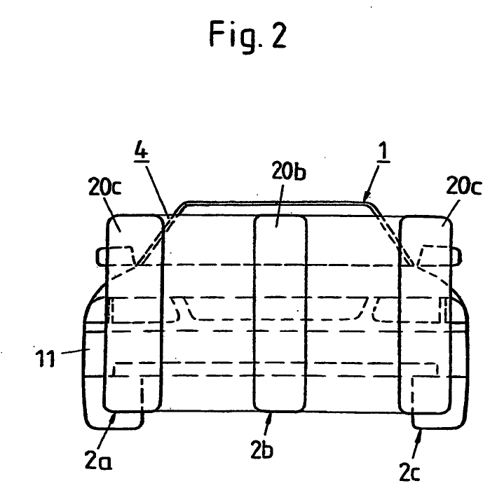

FIG. 2 shows a frontal view of a vehicle with a device according to the invention in an embodiment having three airbags and a connecting surface stretched between them;

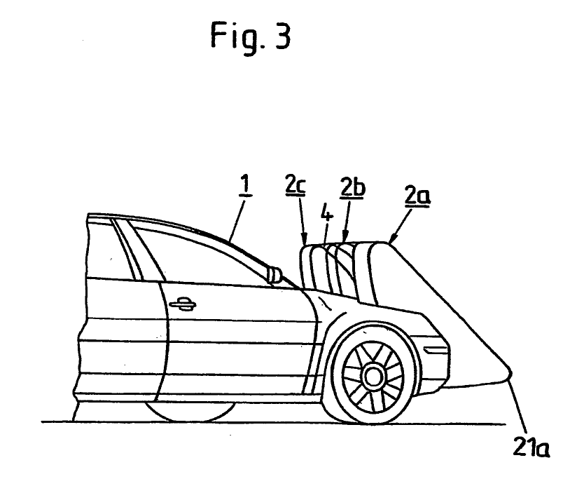

FIG. 3 shows a perspective view of the vehicle with the device according to the invention from FIG. 2;

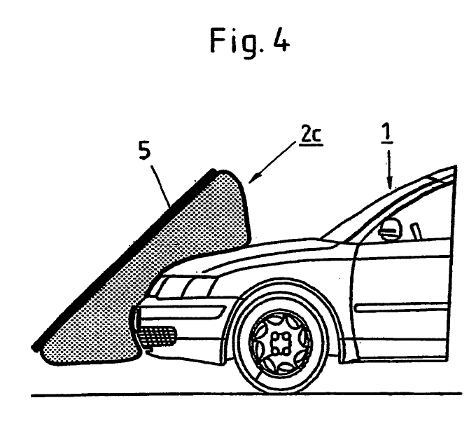

FIG. 4 shows a lateral view of a vehicle with a device according to the invention for protecting a person outside a motor vehicle, with a connecting surface formed as a high-pressure airbag;

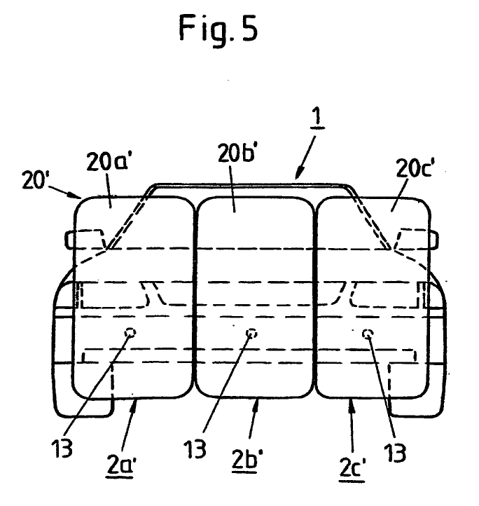

FIG. 5 shows a frontal view of a vehicle with a device according to the invention having three airbags directly adjoining to one another;

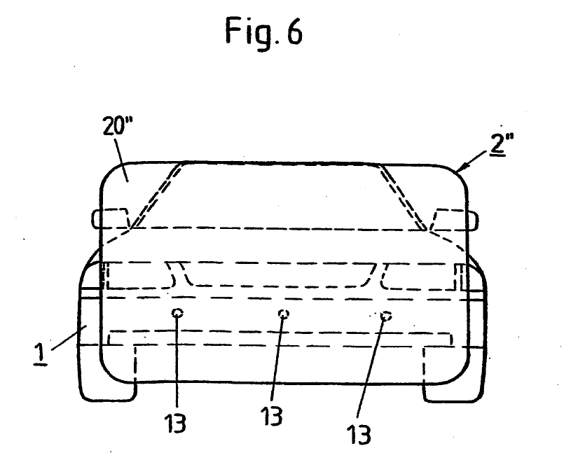

FIG. 6 shows a frontal view of a vehicle with a device according to the invention having one airbag which covers the entire width of the vehicle;

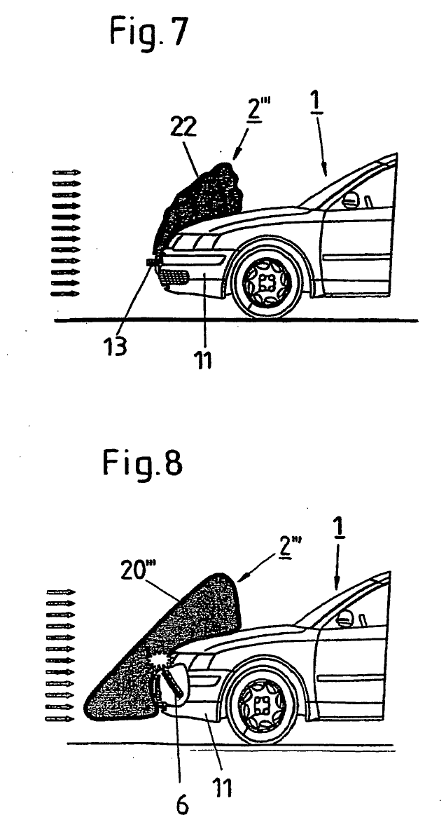

FIG. 7 shows a schematic illustration of the partial filling of an airbag with relative wind through an air inlet in the vehicle;

FIG. 8 shows a schematic illustration of the airbag in FIG. 7 when completely inflated;

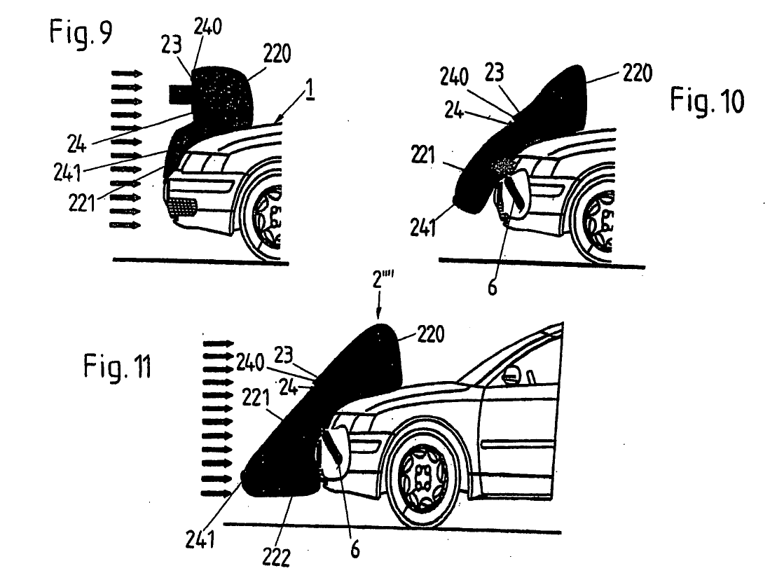

FIG. 9 shows a schematic illustration of an airbag having an opening of the partial filling of the airbag with relative wind in a first phase in which filling takes place only with relative wind;

FIG. 10 shows a schematic illustration of the airbag in FIG. 9 in a second phase, in which a gas generator is ignited and the opening for filling with relative wind is closed;

FIG. 11 shows a schematic illustration of the airbag in FIGS. 9 and 10 when completely inflated, with an opening for filling with relative wind completely closed;

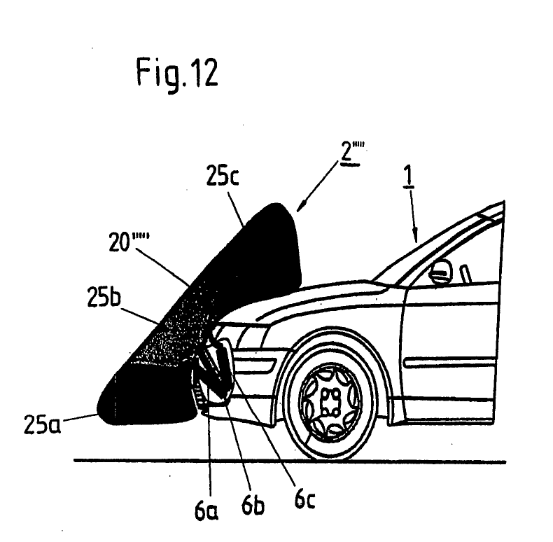

FIG. 12 shows a side view of a vehicle with a device according to the invention for protecting a person outside a motor vehicle with an airbag which comprises three chambers which can be filled with different pressure;

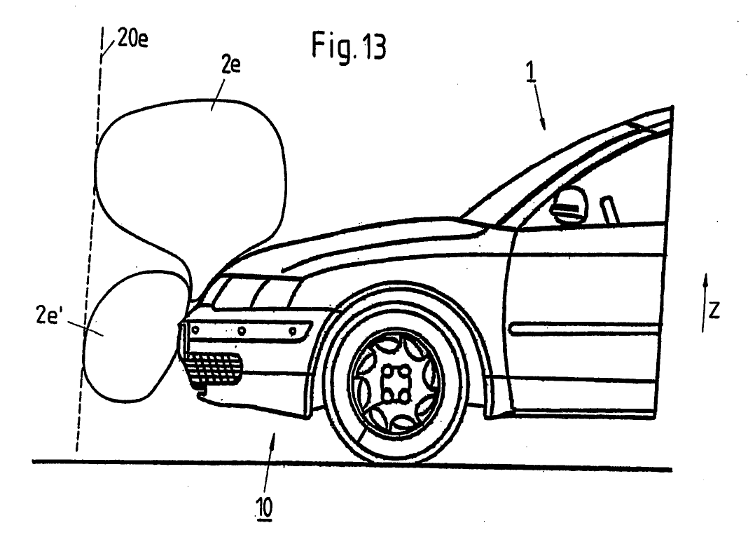

FIG. 13 shows a side view of a vehicle with a device according to the invention for protecting a person outside a motor vehicle with two airbags arranged one above another in relation to the motor vehicle, the lower airbag being more highly pressurized than the upper one in a state prior to the impact of a person; and

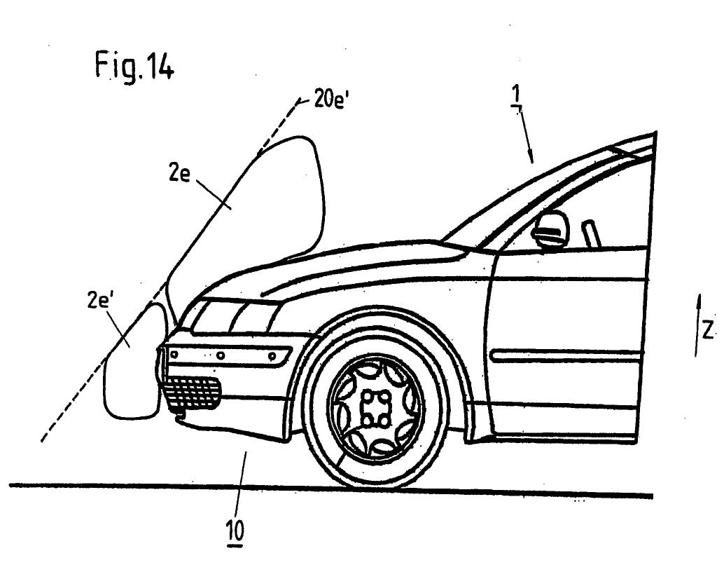

FIG. 14 shows a side view of the vehicle from FIG. 13 after the impact of a person.

FIG. 1 shows the front region 10 of a motor vehicle 1, on which an airbag 2 according to the invention for protecting people outside the motor vehicle 1, here a pedestrian 3, is arranged. The airbag 2 is illustrated in FIG. 1 in an already completely deployed and inflated state.

The airbag 2 comprises, in its lower region, a contact region 21 which is at the greatest distance from the vehicle body 1 perpendicularly to the vertical axis of the vehicle in comparison to the other regions of the airbag 2. In the embodiment shown here, the contact region 21 of the airbag 2 is furthest away from the body of the vehicle 1 in the direction of travel. In this contact region 21, a first contact between the airbag 2 and the pedestrian 3 takes place in the event of a collision. In this arrangement, the contact region 21 comes into contact with the pedestrian 3 below the center of gravity of his body, in FIG. 1 in the region of the lower legs 30 of the pedestrian 3.

The contact region 21 is adjoined by an impact surface 20 which is inclined toward the pedestrian 3, is inclined in relation to the plane formed perpendicularly to the vertical axis of the vehicle, and rises counter to the direction of travel. The impact surface 20 thus forms, with respect to the carriageway, a type of “wedge” by means of which the pedestrian 3 is lifted from the carriageway onto the impact surface 20 during a collision.

The refinement shown in FIG. 1 enables the lower region 21 of the airbag 2, in the embodiment shown, to firstly come into contact with the lower legs 30 of the pedestrian 3 in the event of a collision. This contact region 21, which is situated below the center of gravity of the body of the pedestrian 3, causes the pedestrian 3 to rotate during the collision in such a manner that the upper body moves in the direction of the impact surface 20 of the airbag 2 and the legs 30 move in the opposite direction. The pedestrian 3 is therefore virtually “rolled” onto the impact surface 20 of the airbag 2 because of the low-lying contact with the airbag 2. The pedestrian 3 then gradually comes into contact with the impact surface 20 of the airbag 2.

The impact surface 20 of the airbag 2, which surface is inclined toward the pedestrian 3, has an extent in which the pedestrian 3, and in particular also the head 31 of the pedestrian 3, can be fully received. To this end, the impact surface 20, in the direction of travel, is at least the length of the average height of a person.

The inclination with respect to the plane formed perpendicularly to the vertical axis of the vehicle, and the stiffness of the impact surface 20 can be adapted to the particular conditions, i.e. can be made dependent in particular on the approach speed or the estimated angle of impact of the pedestrian 3. The triggering of the airbag 2 is brought about here via proximity sensors 13 which detect an imminent impact of a pedestrian 3 against the vehicle 1. In one advantageous embodiment, the proximity sensors 13 also identify the size and movement of the pedestrian in order to be able to determine the imminent point of impact of the pedestrian 3 and in order then to be able to appropriately orient the airbag 2 optimally in terms of inclination and hardness.

The airbag 2, when it is not in use, is integrated into a bumper 11 or into a protective strip 12 of the vehicle 1 or is at least covered by them. The proximity sensors 13 may also be integrated directly into the bumper 11 or trim strip 12.

FIG. 2 shows a device for protecting people outside a motor vehicle, in which three spatially separated airbags 2a, 2b, 2c, when deployed and inflated, are connected to one another by a connecting surface 4. The impact surfaces 20a, 20b and 20c of the airbags 2a, 2b, 2c have the same orientation and, in the event of a collision, are inclined toward the person outside the motor vehicle. In this case, the airbags 2a, 2b, 2c are shaped in the same manner as the ones described for FIG. 1 and serve as a support and for orienting the connecting surface 4. The connecting surface 4 has the same properties as the airbags discussed with respect to FIG. 1.

The connecting surface 4 consists, for example, of airbag fabric which is stretched between the individual inflated airbags 2a, 2b, 2c. The embodiment with the three spatially separated airbags 2a, 2b, 2c and the connecting surface 4 stretched between them enables a large region of the vehicle to be covered—in the example shown here the entire front of the vehicle. The use of the smaller airbags 2a, 2b, 2c makes it possible to save on airbag volume, as a result of which smaller and/or more cost effective gas generators can be used, and because of the smaller volume, the deployment process can take place in a more rapid and controlled manner.

FIG. 3 shows the arrangement of the three spatially separated airbags 2a, 2b, 2c from FIG. 2 in a different perspective. The configuration of the individual airbags 2a, 2b, 2c in the same manner as described with respect to FIG. 1 can clearly be seen. In particular, the impact surface 20, which is inclined toward the person outside the motor vehicle, and the contact region 21a, which is situated below the center of gravity of the body of the person and which is pushed forward, can be seen, this impact surface and contact region permitting the advantageous impact sequence according to the invention as described, inter alia, with respect to FIG. 1.

FIG. 4 shows a further embodiment of the device shown in FIGS. 2 and 3 for protecting people outside the motor vehicle, with three spatially separated airbags and a connecting surface 5. Only an outer airbag 2c on which a further airbag 5 of sheet-like design is mounted as the connecting surface can be seen in the side view shown in FIG. 4. In this case, a high-pressure airbag 5 is provided as the airbag of sheet-like design. The design of a high-pressure airbag 5 achieves greater stiffness between those regions of the connecting surface 5 which is situated between the three spatially separated airbags 2a, 2b, 2c. The impact behavior of a person is therefore largely homogeneous over the entire surface covered by the airbag 2a, 2b, 2c, 5. The advantages described with respect to FIG. 3 in regard to the smaller volume of the airbags 2a, 2b, 2c also apply for the device shown in FIG. 4, but the impact behavior over the entire surface is more homogeneous.

FIG. 5 shows a device for protecting people outside the motor vehicle, with three airbags 2a′, 2b′, 2c′. The impact surfaces 20a′, 20b′, 20c′ have the same. orientation and adjoin one another essentially without a gap. An essentially continuous impact surface 20′ which is formed by the three airbags 2a′, 2b′, 2c′ and is inclined toward a person is thus provided. The airbags 2a′, 2b′, 2c′ are further formed in such a manner that the first contact with the person takes place below the center of gravity of his body, so that this embodiment also achieves the desired advantageous, successive contact of the person with the airbag or the airbags 2a′, 2b′, 2c′, in which the person comes gradually into contact with the essentially continuous impact surface 20′.

The use of proximity sensors 13 and a corresponding evaluation means (not shown) means that, in this embodiment, it is sufficient in the circumstances to deploy only one or at maximum two of the airbags 2a′, 2b′, 2c′ during a collision and not to use the rest of them. To this end, the anticipated point of impact of the particular person during a collision has to be calculated fron the current proximity data and then a decision has to be made as to whether the point of impact is anticipated in the center between two airbags 2a′, 2b′, 2c′ and whether these two airbags 2a′, 2b′, 2c′ therefore have to be inflated, or whether the point of impact will take place centrally on one airbag 2a′, 2b′, 2c′ and therefore only this one airbag 2a′, 2b′, 2c′ has to be inflated. This adaptive deployment of the airbags 2a′, 2b′, 2c′ enables costs to be saved in the event of a collision with a person without, however, the protective effect being impaired. Since only a maximum of two airbags 2a′, 2b′, 2c′ ever need to be inflated, gas generators may also be saved; for example, use may also be made of in total just two gas generators which are connected to the particular airbags 2a′, 2b′, 2c′ via corresponding gas-conducting lines.

FIG. 6 shows the device for protecting a person outside the motor vehicle in a further embodiment of just a single airbag 2″. In this case, the airbag 2″ has the configuration already described with reference to FIG. 1, i.e. in particular, a contact region which is situated in the lower region of the airbag 2″, comes into first contact with the person below the center of gravity of the body of the person and is the furthest away from the vehicle body, and an impact surface 20″ which adjoins said contact region, is inclined towards the person and on which the person can be received.

FIGS. 7 and 8 show a further refinement of a device for protecting people outside a motor vehicle 1 with an airbag 2′″ acting outside the motor vehicle 1. In this case, the relative wind, which is illustrated by the arrows, is used for inflating the airbag 2′″ up to a certain pressure limited by the traveling speed.

In FIG. 7, the airbag 2′″ can be seen at an instant shortly after being triggered. The relative wind is conducted into the airbag covering 22 through an air inlet opening 13 in the bumper 11 of the vehicle 1. As a result, the airbag covering 22 is gradually inflated up to a certain pressure. The pressure depends here primarily on the speed of the vehicle 1 at the particular instant and is monitored, for example, via pressure sensors (not illustrated). After a certain time after the triggering, if a certain distance from the pedestrian is falling short of or after a certain, speed-dependent pressure is exceeded, the air inlet opening 13 is closed and the gas generator 6, as shown in FIG. 8, is ignited. The airbag 2′″ is now brought to the desired operating pressure by the gas flowing out of the gas generator 6 into the airbag covering 22. The deployed and inflated airbag 2′″ then has the configurations described with reference to FIG. 1 in regard of the inclination of the impact surface 20′″ and the contact region.

FIGS. 9 to 11 show a further embodiment of the device according to the invention for protecting a person outside the motor vehicle in the event of a collision with an airbag 2″″ acting outside a vehicle 1. The airbag 2″″ is, as already described with reference to FIGS. 7 and 8, initially filled up to a certain pressure by the relative wind (likewise illustrated here as arrows).

In the embodiment shown, an air inlet 23 is provided in the airbag 2″″ itself. The airbag has an upper chamber 220 and a lower chamber 221, the air inlet 23 being situated on the upper chamber 220. As can be seen in FIG. 9, the air inlet 23 is designed as an opening in the airbag. The upper chamber 220 of the airbag 2″″ is inflated by the relative wind, the opening to the air inlet 23 being kept in shape by means of an intercepting cable 24. In this case, the intercepting cable 24 is fastened on the one hand, to the airbag fabric, which forms the upper part 240 of the opening 23, and, on the other hand, to a fixing point 241 in the region of the lower chamber 221. The intercepting cable 24 also, in particular, prevents the air inlet 23 into the airbag 2″″ from being bent over rearward by the relative wind.

If a certain pressure is reached in the upper chamber 220, and if a certain time has elapsed since the triggering of the airbag 2″″ and/or a certain distance from the person outside has been fallen short off, then the gas generator 6, as shown in FIG. 10, is ignited. The gas which is produced is conducted from the gas generator 6 into the lower chamber 221 of the airbag 2″″ which thus begins to be deployed. The expansion of the lower chamber 221 simultaneously exerts, starting from the fixing point 241, a tension on the intercepting cable 24 which, for its part, exerts a tension on the airbag fabric forming the upper part 240 of the opening 23. The opening 23 is thereby closed and, because of the rising pressure in the lower chamber 221 and the resultant severe tension of the intercepting cable 24, is closed in a largely gastight manner. The pressure in the two chambers 220, 221, which are connected via a channel 222, now rises up to the desired operating pressure and the airbag 2″″ has the advantageous shape already described above, as can be seen in FIG. 11. The prefilling of the airbag 2″″ with relative wind enables a smaller gas generator 6 to be used, as a result of which costs and weight can be saved.

FIG. 12 shows the device according to the invention with an airbag 2″″ in a further embodiment. The airbag 2″″ has three separate chambers 25a, 25b, 25c which are supplied with gas by a respective gas generator 6a, 6b, 6c. The three chambers 25a, 25b, 25c can therefore be pressurized to different extents and also can be filled at different times, so that the impact surface 20″″ of the airbag 2″″ can be adapted in each case in an optimum manner to the impact situation. For example, different degrees of hardness can be set in different sections of the impact surface 20′″″. Also, a particularly soft contact with the head can be achieved by filling the upper chamber 25c to a lesser extent. The particular filling of the chambers 25a, 25b, 25c can take place again on the basis of the data of a proximity sensor and a resultant calculation of the impact kinematics.

FIGS. 13 and 14 show a further embodiment of the invention. In this case, a device protecting people outside is provided again in the front region 10 of a motor vehicle 1. The device has two airbags 2e, 2e′ which are arranged one above the other with respect to the vehicle 1, the airbag 2e′ arranged in the lower region being more highly pressurized than the airbag 2e arranged in the upper region.

In the example shown, the airbag 2e′ arranged at the bottom has a smaller volume than the airbag 2e arranged at the top. The effect achieved as a result, for example when a structurally identical gas generator (not illustrated here) is used in each case for the two airbags 2e, 2e′, is that a higher pressure prevails in the lower airbag 2e′ than in the upper airbag 2e. The use of structurally identical gas generators here provides significant cost advantages.

The impact surface 20e formed by the two inflated airbags 2e, 2e′ extends largely perpendicularly to the longitudinal axis of the vehicle 1 in the starting position shown in FIG. 13. In this starting position of the two airbags 2e, 2e′, contact has not yet taken place with a person outside the motor vehicle, but is imminent. The airbags 2e, 2e′ are already fully deployed and pressurized to the extent assigned in each case.

The igniting of the gas generators (not illustrated here) filling the airbags 2e, 2e′ takes place here via proximity sensors which, together with an evaluation unit (likewise not illustrated), detect and evaluate an imminent impact of a person against the vehicle 1.

When the person impacts against the two completely inflated airbags 2e, 2e′, he first of all comes into contact with the largely vertical impact surface 20e (illustrated in FIG. 13) which is formed by the two airbags 2e, 2e′. In the process, the upper body of the person comes essentially into contact with the upper airbag 2e while the person's leg region comes into contact with the lower airbag 2e′.

Owing to the fact that the lower airbag 2e′ is more highly pressurized than the upper airbag 2e, the lower airbag 2e′ also initially exerts a greater force on the person. This force exerted by the lower airbag 2e′ acts below the center of gravity of the body of the person and causes the application of a slight moment of rotation on the person causing the upper body to be rotated in the direction of the motor vehicle 1. Since, however, the person is also already in contact with the upper airbag 2e in the region of his upper body, the upper body now submerges into the upper airbag 2e which exerts a smaller force on the person. This results in the upper body of the person, after the first contact with the two airbags 2e, 2e′, being moved in the direction of the vehicle and then gradually being submerged into the upper airbag 2e. The person is thus as it were rolled into the airbag and is intercepted gently therein.

The relative movement of the person in relation to the vehicle ends after some time in the position on the airbags 2e, 2e′ in the front region of the motor vehicle, which position is illustrated in FIG. 14, is sloping and is tilted in relation to the carriageway. At this time, the vehicle speed at this instant and the speed of movement of the person are identical and the entire energy absorption capacity of the device has been used to the optimum extent. In one variant of the invention, the different hardnesses or pressures of the airbags 2e, 2e′ that are necessary for this can be adapted in each case to the prevailing conditions.

When inflated, the two airbags 2e, 2e′ are supported on the vehicle structure, in particular on the front region of the vehicle or on the engine hood, and conduct the forces occurring in the event of a collision into the vehicle.

In one advantageous variant (not illustrated here) of this embodiment, the two airbags arranged one above the other are combined from a single airbag which has two chambers situated one above the other, the lower chamber being more highly pressurized than the upper one. In this case, the impact surface of the fully inflated airbag is again vertical, so that the first contact of the airbag with a person in the event of a collision takes place largely over the whole body of said person. The different hardnesses of the two airbag regions formed by the chambers, which result from the different pressures and the, then lead to the above-described application of a slight moment of rotation of the upper body of the person in the longitudinal direction of the vehicle. However, if the upper body is then immediately received by the upper, softer airbag region and submerges therein, with the result that a continuous contact takes place during the rotation.

The invention is not restricted to the abovementioned exemplary embodiments. The only features essential for the invention are for the device for protecting a person outside a motor vehicle to have at least one airbag acting outside the motor vehicle and for the airbag, when inflated, to comprise, in its lower region in relation to the motor vehicle, a contact region for the first contact with a person in the event of a collision, which region is at the greatest distance from the motor vehicle body perpendicularly to a vertical axis of the motor vehicle in comparison to other regions of the airbag, and for the airbag to comprise an impact surface adjoining this contact region for receiving a person in the event of a collision.

1-37. (canceled)

38. A device for protecting a person outside a motor vehicle comprising:
at least one proximity sensor for detecting factors influencing impact kinematics; and
an airbag positioned to inflate to a position outside of the motor vehicle;
wherein the airbag includes a contact region for making first contact with the person, the contact region being positioned in a lower region of the airbag in relation to the motor vehicle and at a greater distance from a body of the motor vehicle perpendicular to the vertical axis of the motor vehicle than other regions of the airbag,
wherein the airbag includes an impact surface adjoining the contact region for receiving a person after the first contact; and
wherein the airbag is configured so that the inclination or stiffness of the impact surface can be adapted to the detected factors influencing the impact kinematics.

39. The device as claimed in claim 38, wherein the impact surface is inclined with respect to a plane running perpendicular to the vertical axis of the vehicle.

40. The device as claimed in claim 39, wherein the impact surface rises counter to a direction of travel.

41. The device as claimed in claim 38, wherein the airbag is formed essentially in the shape of a wedge.

42. The device as claimed in claim 38, wherein the airbag has at least two chambers which can be pressurized to different extents.

43. The device as claimed in claim 42, wherein each of the chambers is assigned at least one gas generator.

44. The device as claimed in claim 38, wherein the contact region is arranged essentially on a plane below the center of gravity of the person located outside the motor vehicle.

45. The device as claimed in claim 38, wherein the airbag is arranged in a front region of the vehicle.

46. The device as claimed in claim 38, wherein the airbag, when not in use, is accommodated in a bumper and/or a protective strip.

47. A device for protecting a person outside a motor vehicle, in particular pedestrians or cyclists, having at least one inflatable airbag acting outside the motor vehicle, wherein the airbag can at least be partially filled with relative wind.

48. The device as claimed in claim 47, wherein the airbag can be filled with relative wind through an air inlet open in the direction of travel, and the air inlet can be closed in a gastight manner before, during or after ignition of a gas generator.

49. The device as claimed in claim 48, wherein the air inlet is arranged on a vehicle part, in particular the bumper.

50. The device as claimed in claim 48, wherein the air inlet is formed as an opening in the airbag.

51. The device as claimed in claim 50, wherein the airbag has at least one intercepting cable which acts on an edge region of the opening and on a fixing point on the airbag, with the fixing point lying opposite the edge region with respect to the opening, such that, as the pressure in the airbag rises, the opening is closed by the intercepting cable.

52. The device as claimed in claim 51, wherein the airbag has at least two chambers, with the opening leading into a first chamber and the gas generator leading into a second chamber and the fixing point of the intercepting cable being arranged on the second chamber.

53. A device for protecting a person outside a motor vehicle, in particular pedestrians or cyclists, having at least two inflatable airbags which are arranged outside the motor vehicle, the airbags having impact surfaces with essentially the same orientation, wherein the airbags are spatially separated from one another and the impact surfaces are connected to one another by at least one connecting surface of airbag material, the connecting surface having the same orientation as the impact surfaces.

54. The device as claimed in claim 53, wherein the connecting surface is formed by airbag covering material stretched between the airbags.

55. The device as claimed in claim 53, wherein the connecting surface is formed as an airbag.

56. The device as claimed in claim 53, wherein the impact surfaces of the inflated airbags adjoin one another essentially without a gap.

57. The device as claimed in claim 53, wherein the device further includes sensors and the device is configured to deploy only those airbags necessary for an emergency, with the device being capable of leaving at least one airbag not inflated.

58. The device as claimed in claim 53, wherein at least one gas generator is provided for filling the airbags, with a gas generator assigned to each airbag.

59. The device as claimed in claim 53, wherein at least one gas generator is provided for simultaneous filling of at least two airbags.

60. A device for protecting a person outside a motor vehicle, in particular pedestrians or cyclists, having at least one inflatable airbag acting outside the motor vehicle and having at least two chambers, wherein, when the airbag is inflated, at least two of the chambers are arranged one above another along the vertical axis of the motor vehicle, with a chamber arranged in a lower region of the airbag being more highly pressurized than a chamber situated above it.

61. The device as claimed in claim 60, wherein the chamber arranged in the lower region is more highly pressurized than chambers situated above it.

62. The device as claimed in claim 60, wherein an impact surface of the airbag extends essentially perpendicularly to the longitudinal axis of the motor vehicle before the contact with the person.

63. The device as claimed in claim 60, wherein the device is configured to adjust gas pressures prevailing in the airbags and/or chambers to respectively prevailing kinematic conditions of an expected impact.

64. An airbag module for a motor vehicle, comprising:
a gas generator;
at least one proximity sensor for detecting factors influencing impact kinematics;
an airbag positioned to inflate to a position outside of the motor vehicle;
wherein the airbag includes a contact region for making first contact with the person, the contact region being positioned in a lower region of the airbag in relation to the motor vehicle and at a greater distance from a body of the motor vehicle perpendicular to the vertical axis of the motor vehicle than other regions of the airbag,
wherein the airbag includes an impact surface adjoining the contact region for receiving a person after the first contact; and
wherein the airbag is configured so that the inclination or stiffness of the impact surface can be adapted to the detected factors influencing the impact kinematics.
